(19) United States
(12) Patent Application Publication
(10) Pub. No.: US 2011/0177326 A1
(43) Pub. Date: Jul. 21, 2011

(54) BATTERY LABEL AND A BATTERY

(75) Inventor: Noel Mitchell, Wuppertal (DE)

(73) Assignee: UPM RAFLATAC OY, TAMPERE (FI)

(21) Appl. No.: 13/001,438

(22) PCT Filed: Jun. 24, 2009
(86) PCT No.: PCT/FI2009/050563

§ 371 Date: Apr. 1, 2011

(30) Foreign Application Priority Data
Jun. 25, 2008 (FI) 20085639

(51) Int. Cl. B32B 3/00; B32B 7/12

(52) U.S. Cl. 428/336; 428/343

(57) ABSTRACT

A battery label including an oriented face film having a front side and a rear side, and an adhesive layer on the rear side of the face film. The face film is a co-extruded multilayer film including at least one layer which includes a styrene-containing polymer. A battery includes a body and a battery label which is wrapped around the body.

### FIELD OF THE INVENTION

The present invention relates to a battery label and a battery comprising a body and a battery label.

### PRIOR ART

Monoaxially oriented rigid polyvinyl chloride (PVC) films are extremely suitable for the production of pressure sensitive battery labels. However, due to the nature of PVC, those films are regarded as environmentally risky because there are problems associated to the disposal of the PVC films. Therefore, alternative materials would be desirable.

Publication WO 2004/072930 discloses a shrinkable battery label comprising a polymeric base film and a first pressure sensitive adhesive for adhering the label structure to a battery substrate. The polymeric base film is preferably a polystyrene film and its thickness is between 0.01 and 0.05 mm. A transparent polymeric top film overlies the base film. The top film is adhered to the base film by a transparent second adhesive.

A problem related to pure polystyrene films in the manufacture of labels is that the films are prone to tear and therefore, problems in dispensing and slitting occur during the manufacture of the battery label. The polystyrene films also break easily, especially in the machine direction, so that the operation of die-cutting and matrix stripping is very difficult.

A problem related to this specific application is that the battery labels are typically metallized or white. In the case of metallized films, slip additives can damage the metallized layer. In the case of white films, a white masterbatch containing titanium dioxide and dispersing agents is mixed with the film material and thus, the properties of the film may change. Due to the above-mentioned facts, a single-layer face film may not be the best choice.

### DESCRIPTION OF THE INVENTION

A battery label is a label to be wrapped around a body of a battery and attached to the body by an adhesive, usually a pressure sensitive adhesive. The label is set around the body in such a manner that the edges of the label overlap slightly in the longitudinal direction of the body of the battery, i.e. the overlapping part forms a seam. The label is also longer than the body so that the label extends over the edges (lips) of the battery in the longitudinal direction of the body. After the battery label has been wrapped around the body the ends of the label are heat-treated so that the label material shrinks and bends over the edge of the body. In practice, the heat-treating temperatures which are used at different edges of the battery may differ from each other.

The battery label comprises a face film having a front side and a rear side and an adhesive layer on the rear side of the face film. The face film is a co-formed multilayer film, i.e. it has been formed e.g. by one of the co-extrusion techniques in which all the layers of the film are formed simultaneously from melted plastic materials. The face film is oriented but not set, i.e. the face film is able to shrink considerably in a certain temperature range. The face film may be monoaxially oriented but it is also possible that the face film is biaxially oriented. In the case the film is biaxially oriented, the draw ratio in the first direction (usually the machine direction) may be rather high, and the draw ratio in the second direction (usually the cross-direction) may be rather low.

Films, which can be utilized in connection with battery labels, are typically films having a thickness which is less than 70 μm, preferably less than 60 μm. If the label is too thick and too stiff the label will curl and the seam will open. This is both unsightly and technically unacceptable.

The face film may be directly printed, or a pre-printed film may be laminated over the face film of the label. The face film of the label may be colored, typically white, or metallized. When the face film is a white film which is created by mixing a white masterbatch containing titanium dioxide and dispersing agents with the basic film material, the properties of the film may change compared to films having no coloration.

The metallization of the film may be made by a vacuum metallization process. Therefore, the face film which is intended to be metallized, should not contain certain slip additives which could damage the metallization. Therefore, due to the metallized and white films, the manufacturing process is challenging. It is possible that the properties of the face film must be tailored so that it functions properly in regard to the shrinking properties. For example, some slip additives may be omitted, or the amount of the styrene-containing polymer may be decreased or increased according to the required shrinking properties.

Bearing in mind the above-mentioned limitations, there are also certain requirements concerning the heat resistance of the battery labels. The labels should resist a storage stability test which provides that the labels can be stored at a temperature of 71° C. for seven days without the opening of the seam, i.e. the labels should not shrink one percent or more so that the label wrapped around a body of a battery comes open and reveals the body. The storage stability test is used widely in the battery label industry.

In order to enhance the dimensional stability at lower temperatures (around 70° C. as required by the storage stability test) and the ageing resistance, at least one layer of the multilayer film comprises a styrene-containing polymer. On the other hand, the film should shrink at temperatures between 200 and 400° C., i.e. in a range within which the battery labels are heat-treated. Thus, there is a first temperature range within which the film remains dimensionally stable, and a second temperature range within which the film shrinks considerably. Typically the face film shrinks in one direction more than 50% at temperatures above 200° C.

The styrene-containing polymers include, for example, polystyrene and copolymers of styrene. The styrene-containing polymer may also be selected from styrene derivatives. One practical example from materials which can be used is Styrolux HS70 (BASF, Germany). A styrene-containing polymer may coexist in a layer in a blend with at least one other polymer, such as a polyolefin. However, the styrene-containing polymer may exist as such in a layer. Preferred polyolefins are polyethylene and polypropylene. Preferred polyethylenes are HDPE (high density polyethylene) and LLDPE (linear low density polyethylene).

The number of the layers in the multilayer film is not limited but according to an advantageous embodiment, the battery label comprises three layers. At least one of the layers comprises a styrene-containing polymer, such as polystyrene. For example, there may be a three-layer film whose outer layers are made of polyolefin, such as polyethylene, and the inner layer comprises a styrene-containing polymer. The outer polyolefin layers facilitate the manufacturing process, and the inner layer is used for adjusting the shrinking properties. According to another example, a film may comprise three layers which each comprise a styrene-containing polymer. The styrene-containing polymer may form a blend with another polymer, such as one of the polyolefins but it could also be the single polymer in the respective layer. However, the structure comprising outer polyolefin layers and an inner styrene-containing layer may be beneficial from the manufacturing point of view, especially in regard to the matrix stripping and conversion properties.

In the both above-mentioned cases, the thickness of the three-layer film may be from 25 μm to 55 μm, preferably from 30 to 40 μm, if the three-layer film is intended to be overlaminated. However, typically the thickness is less than 50 μm and more than 30 μm. The thickness of the three-layer film may be from 50 μm to 60 μm if the three-layer film is not intended to be overlaminated. In the first example, the polyolefin layers may have a thickness from 4 to 20 μm, and the styrene-containing polymer layer may have a thickness from 20 to 50 μm. In the second example, the styrene-containing polymer layers may have a thickness from 10 to 40 μm. However, the thicknesses of the styrene-containing polymer layers may differ from each other, and the amount of the styrene-containing polymer may vary in each layer.

### DETAILED DESCRIPTION OF THE INVENTION

In the following, the invention will be described by referring to examples and figures in which

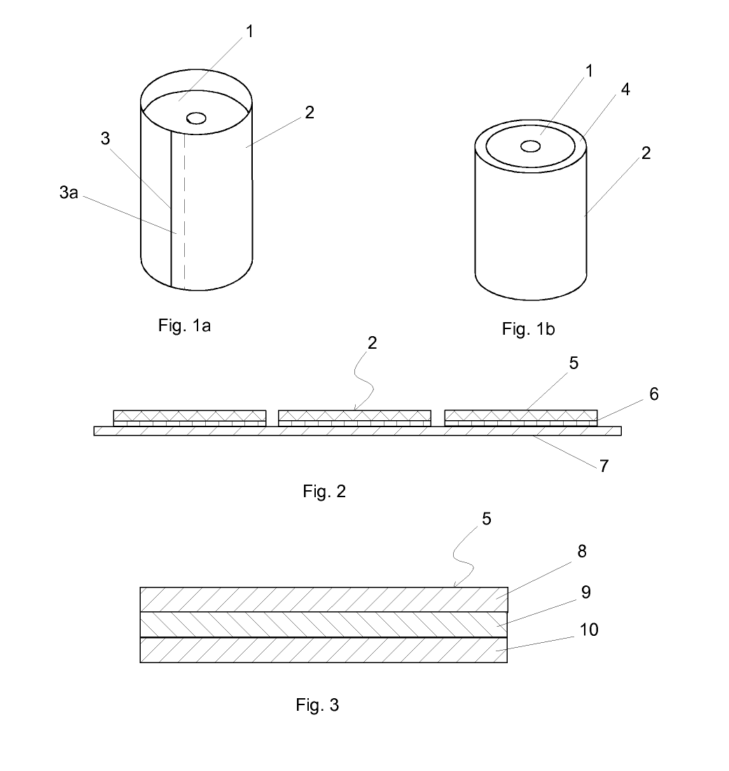

FIG. 1a shows a battery during the manufacture,

FIG. 1b shows the battery when finished,

FIG. 2 shows a cross-sectional view of a web comprising labels of the invention, and

FIG. 3 shows a cross-sectional view of the face film of the label.

FIG. 1a shows a body 1 around which a label 2 is wrapped. The edge 3 of the label may overlap the opposite edge slightly so that a seam 3a is formed. The label extends over the edges (lips) of the battery in the longitudinal direction of the body 1. In FIG. 1 b the label has been shrunk over the edge 4 of the body 1 so that a finished battery has been formed. FIGS. 1a and 1b show cylindrical batteries but other shapes are also possible.

FIG. 2 shows a web comprising battery labels 2. The battery label comprises a face film 5 and an adhesive layer 6. Underneath the labels 2 there is a release surface, such as a release paper 7, or a release film.

FIG. 3 shows a cross-sectional view of one possible face film 5. The face film 5 is a co-extruded three-layer film which comprises a styrene-containing polymer in its one or more layers.

According to one solution, the face film 5 comprises layers 8 and 10 which are made of polyolefin, and layer 9 which comprises a styrene-containing polymer. The styrene-containing polymer may be, for example, polystyrene or copolymers of styrene. A styrene-containing polymer may coexist in a layer in a blend with other polymers, such as polyolefins, but it is also possible that the styrene-containing polymer is the only polymer in the layer.

Preferred polyolefins are polyethylene and polypropylene. Preferred polyethylenes are HDPE (high density polyethylene) and LLDPE (linear low density polyethylene).

According to another solution, the face film 5 comprises layers 8, 9 and 10 which all comprise a styrene-containing polymer. The styrene-containing polymer may be, for example, polystyrene or copolymers of styrene. A styrene-containing polymer may coexist in a layer in a blend with other polymers, such as polyolefins, but it is also possible that the styrene-containing polymer is the only polymer in the layer. Preferred polyolefins are polyethylene and polypropylene. Preferred polyethylenes are HDPE (high density polyethylene) and LLDPE (linear low density polyethylene).

### EXAMPLE

AAA batteries were labelled with labels with a maximum overlap of 2 mm on the seam. The labels comprised pressure sensitive adhesive. There were three different kinds of films, namely a polyvinyl chloride film (PVC), a polystyrene containing film and a polyolefin film. The labelled batteries were kept at a temperature of 71° C. for one week, and after that they were evaluated. The results are shown in table 1.

TABLE 1
Test results of battery labels.

| | Shrinkage (%, measured on a | Seam opening on a |
|---|---|---|
| Film | flat steel plate) | AAA battery |
| PVC | <1 | No |
| Polystyrene | <1 | No |
| containing film | | |
| Polyolefin | >10 | Yes |

As one can see from the test results, the polystyrene containing film produced acceptable results which were as good as with the PVC films.

1-7. (canceled)

8. A battery label, comprising:
an oriented face film having a front side and a rear side, wherein the face film is a co-extruded multilayer film comprising at least an inner layer including a styrene-containing polymer and outer polyolefin-containing layers on both sides of said inner layer; and
an adhesive layer on the rear side of the face film.

9. The battery label according to claim 8, wherein the face film is a three-layer film comprising polyolefin layers as the outer layers and a layer including a styrene-containing polymer as the inner layer.

10. The battery label according to claim 8, wherein the face film is a three-layer film, each layer comprising a styrene-containing polymer.

11. The battery label according claim 8, wherein the styrene-containing polymer is polystyrene or a copolymer of styrene.

12. The battery label according to claim 8, wherein a thickness of the face film is less than 70 μm.

13. The battery label according to claim 8, wherein the face film shrinks less than one percent at temperatures lower than 71° C., and wherein the face film shrinks more than 50% at temperatures between 200° C. and 400° C. in at least one direction.

14. A battery; comprising:
a body; and
a battery label wrapped around the body, the battery label comprising an oriented face film having a front side and a rear side, and an adhesive layer on the rear side of the face film, wherein the face film is a co-extruded multilayer film comprising at least an inner layer including a styrene-containing polymer and outer polyolefin-containing layers on both sides of said inner layer.
